(19) United States
(12) Patent Application Publication
(10) Pub. No.: US 2004/0065636 A1
(43) Pub. Date: Apr. 8, 2004

(54) Container with recessed handle

(76) Inventors: James Thibodeau, Gahanna, OH (US); Jay Deichler, Tampa, FL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/266,374

(22) Filed: Oct. 8, 2002

(51) Int. Cl. B65D 23/10; B29D 22/00

(52) U.S. Cl. 215/398; 264/541; 215/383

(57) ABSTRACT

A container with a recessed handle. A middle portion of a container is positioned between a first and second portion wherein the middle portion has a recessed access area. A handle is positioned in the recessed access area wherein the handle is planar with an exterior of the container.

### BACKGROUND OF THE INVENTION

The present invention relates to containers. In particular, the invention relates to molded plastic containers used to store liquid.

Presently, some liquids such as purified or spring water are packaged, shipped and sold in large plastic containers. Some of these containers are blow molded and cylindrical and do not include handles for loading and/or carrying. Accordingly, users or transporters must grasp the container by the neck and/or its main body portion. Alternatively, someone might carry the container on a shoulder.

Since the purified water usually is transported and delivered on trucks with large racks, and since the containers usually are stored in stores on or in racks, loading and unloading the containers becomes an important economic factor in the bottled water industry in today's fast paced society. Additionally, transporting these containers in an efficient and convenient manner becomes economically essential.

Transporting these containers typically involves loading the container into a module of racks wherein each rack is a standard size which holds an individual container. Upon unloading, the container slides out of the rack and is carried by the transporter via the container's neck or on the transporter's shoulder. Either carrying method, though, can lead to unsafe and unhealthy conditions since the heavy containers create unnatural and awkward carrying positions. Accordingly, these containers are not conducive for efficient handling.

Some persons, in turn, slip a carrying harness around the container during the loading, unloading and carrying process wherein these harnesses include a handle for carrying the container. Thus, the transporter typically unloads the container on the ground, picks up the harness, wraps the harness around the container and then proceeds to pick up the container via the handle. This container handle contains deficiencies, however, for bulk handling. Because of the labor intensive steps, the bulk handling over time with the harness becomes cost prohibitive.

Some containers utilize handles attached to the outer surfaces of the containers. For some of these containers, the handle extends outward from the container for the transporter to grab. This container also contains deficiencies, though. Because of the extended handle, some of these types of containers will not fit into standard size racks. Accordingly, custom racks need to be manufactured to transport these handled containers. Additionally, due to the extended handle, some containers must be loaded in a specific position to fit into the custom rack leading to increased load time. Still further, the rack module requires modification to accommodate the standard non-handled containers and the handled containers leading to inefficient space usage of the cargo hold. Additionally, these handled containers require additional retail shelf space when stacked next to each other. Further, as in the transportation loading, some extended handle containers require specific loading at the retailers to maximize shelf space.

Other containers with integral handles require access space between the handle and the container. However, volume within the container is sacrificed in order to provide this access space. The sacrificed volume may be regained by enlarging the container, but this can result in restructuring of the rack and other storage units to accommodate the larger containers.

### SUMMARY OF THE INVENTION

The present disclosure provides one or more inventions relating to a container with a handle which is recessed into the container and method and apparatus for making same. In a particular embodiment, the disclosure provides an ornamental design for a container.

In an embodiment, the disclosure provides a container with a handle wherein the handle does not extend beyond the container exterior.

The disclosure also provides a container with a recessed handle in which a preexisting container is adapted to include a recessed handle and the volume of the container is appropriately adjusted without increasing the outermost container dimensions.

The disclosure also provides a method of manufacturing the container with the recessed handle using a modular mold as well as the mold.

In an embodiment, the recess is a concavity shaped into the sidewall of the container.

In an embodiment, the handle is hollow and communicates with the interior of the container.

In an embodiment, the handle is sealed at its ends to prevent communication with the interior of the container.

In an embodiment, the recess is substantially a portion of a sphere.

In an embodiment, the recess is curvilinear in cross-section along a surface perpendicular to an axis of the container.

In an embodiment, the recess is curvilinear in cross-section along a surface parallel to the axis of the container.

In an embodiment, the recess is curvilinear in a cross-section along a surface perpendicular to the axis of the container and in cross-section along a surface parallel to the axis of the container.

In an embodiment, the disclosure provides a method for forming a container with a recessed handle in which the follow steps are performed:

a) providing a mold having movable core halves;

b) positioning said core halves in a first extended position;

c) blow molding a container, said mated core halves forming a recess in a sidewall of the container and a handle within the recess;

d) positioning said core halves in a second retracted state; and

e) removing the container from the mold.

In an embodiment, the core halves are structured to provide a handle that is hollow and communicates with the interior of the container.

In an embodiment, the core halves are structure so that during positioning into the retracted state, the handle is sealed at its ends to prevent communication with the interior of the container.

In an embodiment, the mold core halves are structured to form a recess that is curvilinear in cross-section along a surface perpendicular to the axis of the container.

In an embodiment, the mold core halves are structured to form a recess that is curvilinear in cross-section along a surface parallel to the axis of the container.

In an embodiment, the mold core halves are structured to form a recess that is curvilinear in a cross-section along a surface perpendicular to the axis of the container and a cross-section along a surface parallel to the axis of the container.

In an embodiment, the mold is such that a section containing the core halves is modular and removable relative to a remainder of the mold.

These and other features are described next in the detailed description of the presently preferred embodiments with reference being made to the accompanying drawings.

### BRIEF DESCRIPTION OF THE DRAWINGS

FIG. 1 is a perspective view of a container that can embody principles of the invention.

FIG. 2 is a front elevation view of the container of FIG. 1.

FIG. 3 is a side elevation view of the container of FIG. 1.

FIG. 4 is top view of the container of FIG. 1.

FIG. 5 is a back elevation view of the container of FIG. 1.

FIG. 6 is a perspective view of a modular mold embodying principles of the invention.

FIG. 7 is a perspective view of a portion of a mold usable in a manufacturing method embodying principles of the invention.

FIG. 8 is another perspective view of the portion of the mold portion of FIG. 7.

FIG. 9 is a perspective view of a mold section embodying principles of the invention.

### DETAILED DESCRIPTION OF THE PRESENTLY PREFERRED EMBODIMENTS

The present disclosure provides a plastic molded container, preferably a blow molded container, with an improved handle. In particular, the disclosure provides for a container handle which is formed in a recess in the container. Accordingly, the container can be efficiently handled, transported and stored, particularly in already existent racks for containers meeting the outer dimensional specifications of the racks.

In the embodiment described next, the present invention provides a container handle which improves the use and adaptability of a container for heavy material such as bottled water. Accordingly, the present invention provides such a container handle and manufacture of the same which increases the use, stability and convenience of a container which leads to consumer satisfaction and preference.

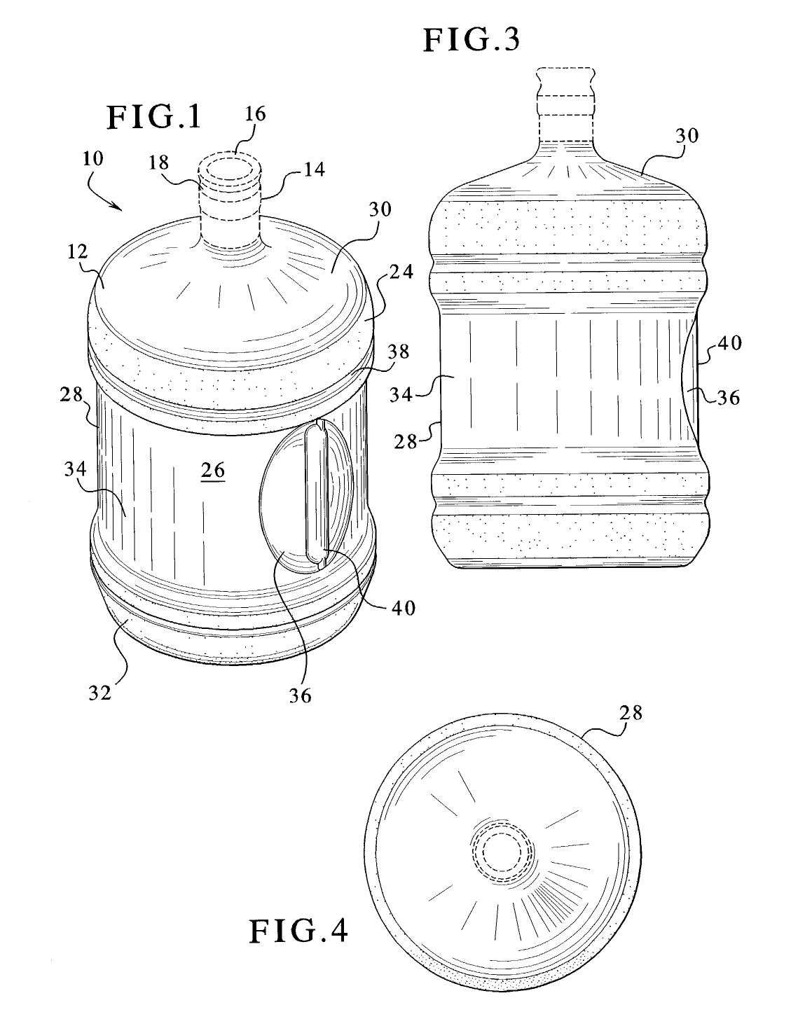

FIG. 1 illustrates in perspective view an exemplary container 10. Container 10 represents a modified version of the present assignee's five gallon purified water container marketed as model SR-7. Model SR-7 does not include a handle or a recess therefore.

As illustrated, the container 10 includes a body 12 with an opening 16 through which liquid or non-liquid materials may pass into or out of the container 10. The neck 14 attaches to the body 12 at the opening 16 and is appropriately structured to receive a cap (not shown). A ridge may also aid in the final polishing of the neck 14 while also providing a surface to which a tamper-proof feature may attach during the placement of the cap on the neck 14. The container 10 also includes rough surfaces 24 to assist frictionally in handling the container 10 and to aid in preventing scratching of adjacent containers. The container 10 includes an interior 26 which contacts the contained material such as the water. Accordingly, the container 10 includes an exterior or sidewall 28 to protect the contained material. The container 10 comprises a blow molded thermoplastic such as, but not limited to, polycarbonate. Moreover, the container's side wall may be comprised of one or more layers, as may be appropriate for the intended contents or use thereof.

As further shown in FIG. 1, the container 10 includes what can be referred to as first portion 30, second portion 32 and a middle portion 34. Although ribs 38 typically separate the portions, the first portion 30, second portion 32 and middle portion 34 preferably are unitarily molded to form the container 10.

Still referring to FIG. 1, the middle portion 34 has an access area or recess 36 which is recessed into the middle portion 34. Accordingly, the recess 36 is shaped to provide a concavity, preferably an inverted dome, into the interior 26 of the container 10. The recess 36 is curvilinear in cross-section while being positioned between the ribs 38. Preferably, the recess 36 is curvilinear in cross-section along a surface perpendicular to an axis of the container extending from the neck 14 to the bottom and a cross-section along a surface parallel to the axis. As further shown in FIG. 1, a handle 40 is positioned within the recess 36.

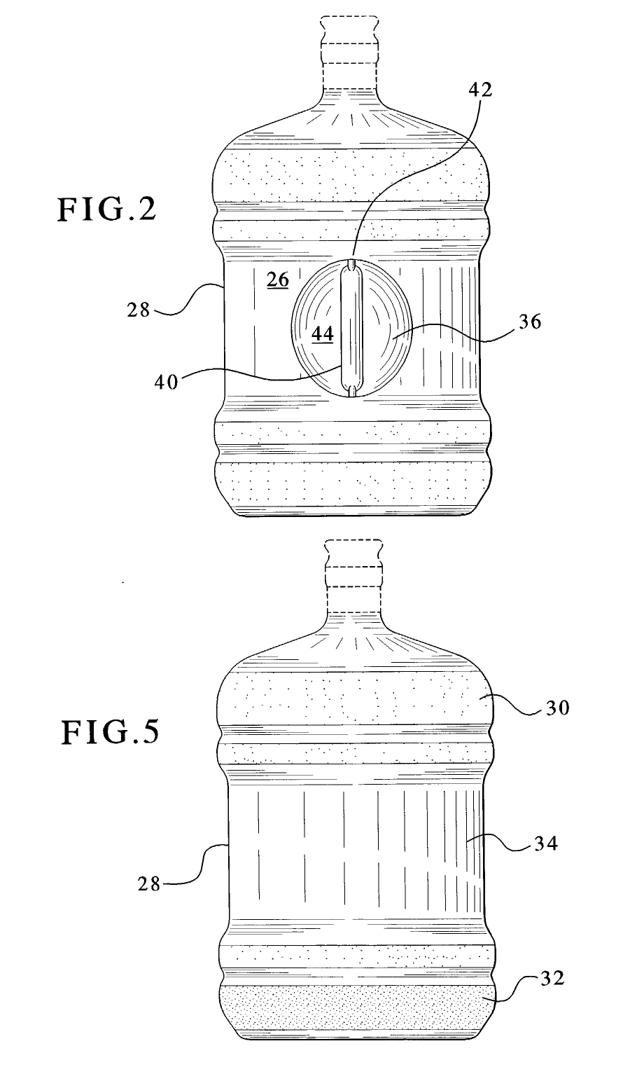

Turning to FIG. 2, the handle 40 may connect to the recess 36 at pinch points 42. These pinch points 42 may completely seal the handle 40 from the interior 26. However, the handle 40 may be formed to not include the pinch points and be hollow, thereby providing communication with the container interior 26. Because of the shape of the recess 36, a space 44 exists between the handle 40 and recess a 36 for a user to conveniently grasp the handle 40, as is discussed below.

Turning to FIG. 3, a side elevational view of the container 10 is shown. In this view, the handle 40 can be seen. Since the handle 40 is positioned within the recess 36, the handle 40 does not extend outward from the container 10. Preferably, the handle 40 is formed to be flush with the sidewall 28 of the container 10. Accordingly, the edge of the handle 40 is positioned planar with the exterior of the middle portion 34. This positioning is also illustrated in FIG. 4.

In FIG. 5, it can be seen that the handle 40 and recess 36 do not interrupt the continuity of the remainder of the container exterior 28. Further, since the recess 36 positioned in the middle portion 34 eliminates some volume of the interior 26, the volume of the interior 26 may remain the same as a non-handled container by increasing the diameter of the middle portion 34.

As also shown in FIG. 5, the middle portion 34 has a smaller diameter than the first portion 30 and the second portion 32 while including the recess 36 and the handle 40. Accordingly, the present invention accommodates volume loss caused by the inclusion of the recess 36 and the handle 40 by permitting an increase in the diameter of the middle portion 34, while still maintaining the diameter of the middle portion 34 to be less than the outermost diameters of the first portion 30 and the second portion 32. Thus, the present invention accommodates a recessed handles, while maintaining conformity with preexisting outer dimensional requirements.

It can also be appreciated that the particular embodiment disclosed in FIGS. 1-5 imparts an ornamental design that is pleasing to the eye. In its utilitarian aspects, the exact shapes of the recess and handle may be varied in accordance with the principles discussed herein.

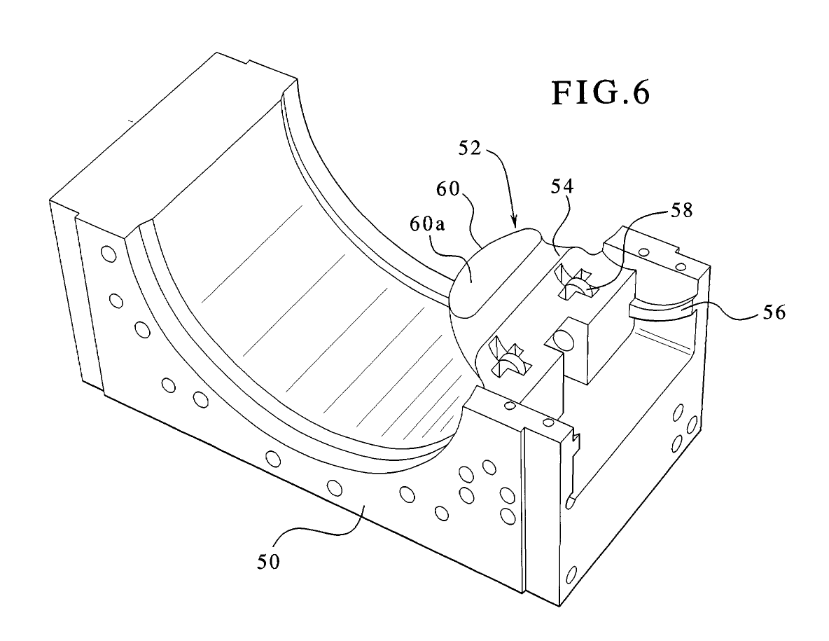

Turning to FIGS. 6-9, a modular section 50 of a mold for manufacturing the container 10 is shown. Generally in blow molding, a parison is inserted between two mold halves positioned in an open position. The mold halves are then closed about the parison and a gas is injected into the parison to cause it to fill with the gas and the material to be applied to the interior surfaces of the mold halves. Thereafter, the mold halves are opened and the blow-molded article is extracted from the mold.

In the present disclosure, portions of the mold halves include movable core halves that are independently closed and retracted during the blow molding process. That is to say the mold core halves are movable relative to the mold halves and can be retracted even when the mold halves are closed or open, as might be appropriate.

Referring to FIG. 6, a mold preferably includes various sections that can be assembled together to form each mold half. In forming the container 10, the mold halves can include at least three sections, a top section for the forming the first portion 30 of the container 10, a middle section for forming the middle portion 34 and a bottom section for forming the bottom portion 32. Of course, the number of sections used is up to the manufacturer depending on the desired shape of the container, and the sections needed to impart that shape.

In this disclosure, FIG. 6 illustrates the modular section 50 of a mold section which can be the middle section for forming the middle portion 34, of the preferred container 10. To that end, FIG. 6 generally illustrates one half of the modular section 50 which is removably inserted into the mold to form the recessed handle 40 during the blow molding process. Accordingly, an existing standard mold can incorporate the modular section 50. Thus, the modular section 50 may correlate to the middle portion 34 of the container 10. An advantage of the present invention, therefore, is that the top and bottom sections of the mold remain the same regardless whether a handled or non-handled container 10 is being manufactured since the modular section 50 (correlating to the middle portion 34, handle 40 and recess 36) easily inserts into the mold. Thus, considering the present assignee's model SR-7, the top and bottom mold section can be the current sections used to make the SR-7 container.

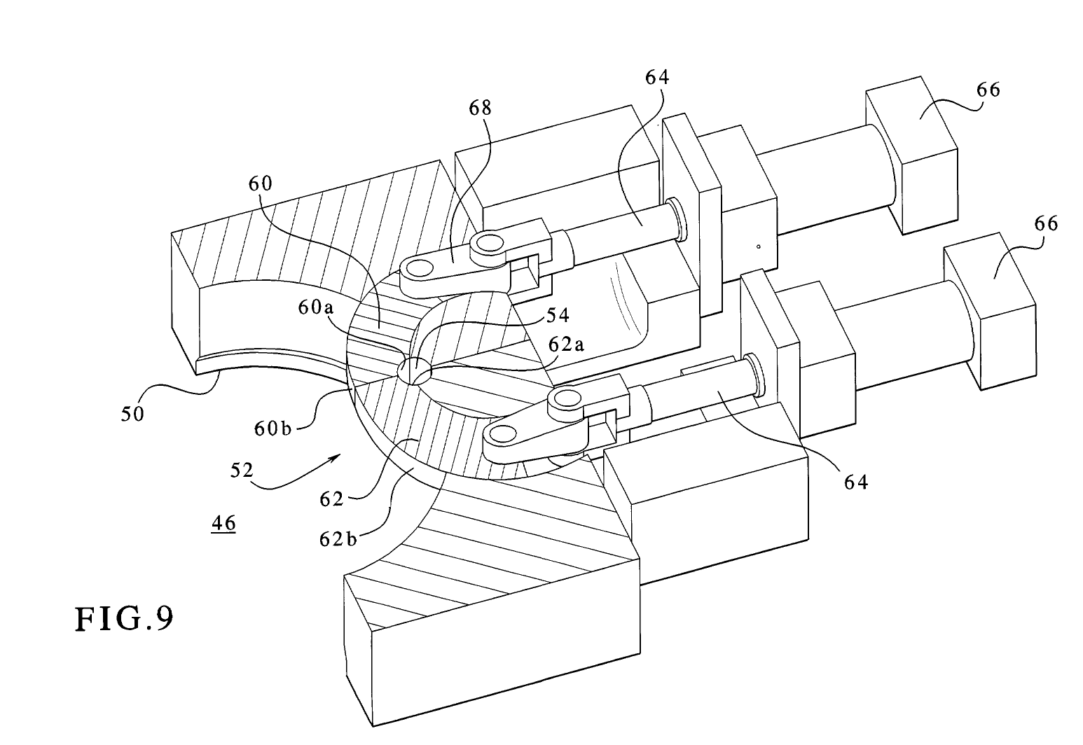

FIG. 6 illustrates a perspective view of the modular section 50 wherein a mirror half completes the modular section 50 as shown in FIG. 9. The modular section 50 includes at least one core 52. In the illustrated embodiment of FIG. 9, the core comprises two core halves 60, 62. In FIG. 6, core half 60 is shown wherein core half 60 includes a core face 60a. Turning to FIG. 9, core halves 60, 62 are shown in an extended mated positions wherein core face 60a and core face 62a mate when extended at the mold or parat line. As illustrated, FIG. 9 represents a cut away view of the modular section 50 wherein portions of the modular section 50 and core halves 60, 62 are shown in hatched lines. Accordingly, upper portions of the modular sections 50 and core halves 60, 62 are removed for clarity. Further as shown in FIG. 9, core halves 60, 62 each have a core exterior 60b, 62b which may be curvilinear shaped. The core halves 60, 62 travel between an extended portion and a retracted portion wherein the core halves 60, 62 are shown in the extended position in FIG. 9. Returning to FIG. 6, each of the core halves 60 and 62 travels on guide rails 56 formed in the modular section 50 wherein bearings 58 assist the travel of each core half along the guide rail 56.

In the extended position of FIG. 9, the core 52 forms a channel 54. Typically, the channel 54 is circular in cross section to produce a tubular shaped handle, although other shapes may be used. Each of the core faces 60a and 62a partially form the channel 54 when the core halves 60, 62 are brought together in their extended positions. The balance of the channel 54 is formed from modular section faces 50a (shown in FIG. 6) which remain fixed to the modular section 50. Accordingly, each of the core faces 60a, 62a and the modular section faces 50a comprise a quarter portion of the channel 54. As shown, the core exteriors 60b and 62b of the core halves 60 and 62 that face the interior of the mold cavity may form a semi-spherical shape when the core halves 60, 62 are in abutting relationship.

It can be appreciated that, given an axis of the resultant container 10 that runs from the neck 14 to the bottom, the surface formed by the core halves 60, 62 and the respective core exteriors 60b and 62b is curvilinear along a surface either parallel or perpendicular to the axis of the container. While other shapes may be used, this shape has particular advantages explained below. As is described, the shape of the channel 54 defines the shape of the handle 40. Additionally, the core exterior 60b and 62b of the core halves 60 and 62 define the outer surface of the recess 36. Accordingly, the core faces 60a, 62a and core exteriors 60b, 62b preferably are shaped to define the desired shapes of the recess 36 and handle 40.

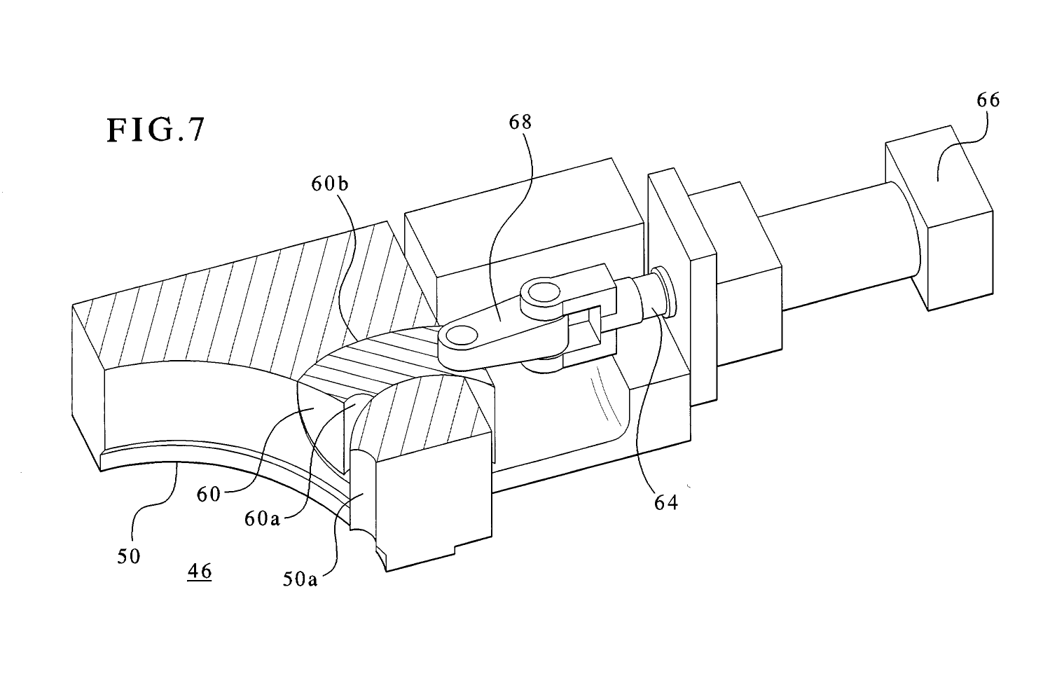

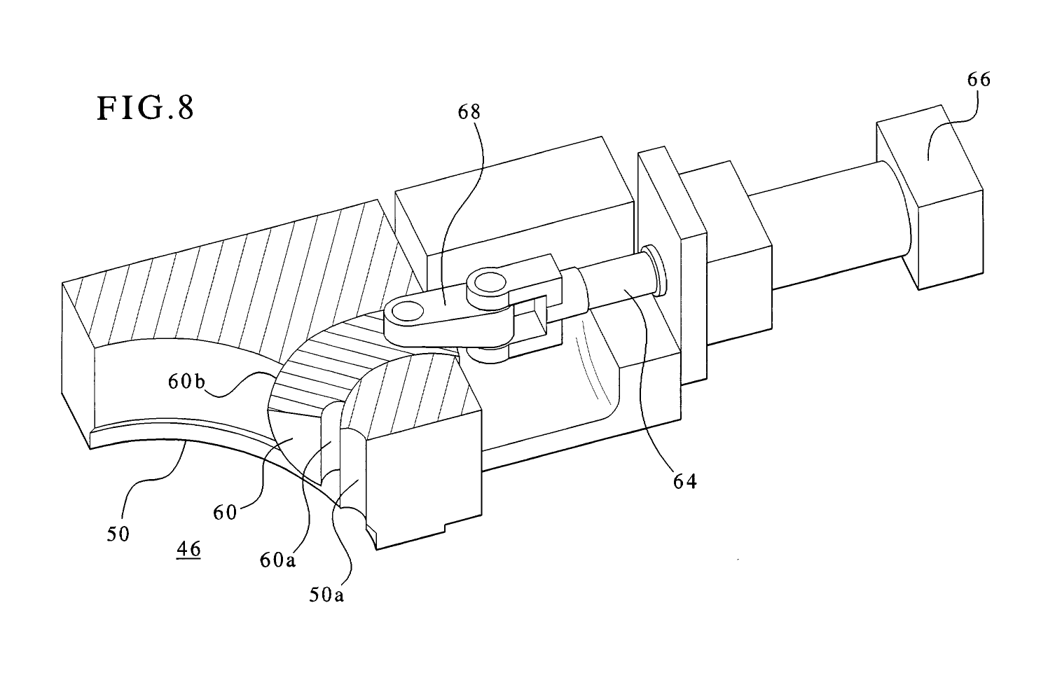

Turning to FIGS. 7-9, during the manufacturing process, the modular section 50 is inserted into the mold. Prior to closure of the mold halves about a parison, the core halves 60, 62 are moved from the retracted position (FIG. 7) through to the half way position (FIG. 8) to the extended position (FIG. 9). Once extended, the parison is inflated in the usual way with a pressurized gas to cause the plastic material thereof to expand against the mold cavity walls. As shown, FIGS. 7-9 illustrate cut away views of the manufacturing process where only one half is shown in FIGS. 7 and 8 where the mirror half for each is removed for clarity.

To that end, FIG. 7 illustrates a portion of the mold section in which the core half 60 is shown in it retracted position. Each of the core halves 60 and 62 may be rotated into a fully extended position into the mold by a respective hydraulic piston 64 operated by a suitable controller 66. As the hydraulic piston 64 extends, a clevis 68 attached to the core half 60 rotates the core half 60 into the interior of the mold cavity 46. While rotating, the core half 60 travels along guide rails 56 (shown in FIG. 6) via bearings 58 (shown in FIG. 6). In the retracted position, the core face 60a and the modular section face 50a are separated while the core exterior 60b is positioned outside the mold cavity 46 and within the modular section 50.

In FIG. 8, the core half 60 is shown halfway through its rotation into the extended state. At this point it can be seen how the core half 60 is rotated along the guide rails 56 wherein the core face 60a rotates toward the modular section face 50a and the core exterior 60b rotates into the mold cavity 46. The modular section face 50a remains fixed while the core half 60 moves into the extended position.

In FIG. 9, both core halves 60 and 62 are shown in their fully extended position. The channel 54 is shown while appropriate faces 60a, 62a, 50a are formed in the mating or abutting surfaces of the core halves 60 and 62. After the container 10 is formed via the blow molding, the core halves 60 and 62 are rotated to their fully retracted positions to expose the recess 36 and the handle 40 and to enable extraction of the container 10.

During the blow molding, the channel 54 forms the handle 40 while the core exteriors 60b, 62b of the core halves 60 and 62 define the exterior surface of the recess 36. During the blow molding process, the parison flows through the channel 54 to form the handle 40 and around the core halves 60, 62 to form the recess 36. The channel 54 is open at both ends, thereby to form a handle 40 that is open at its opposite ends, i.e., the interior of the handle is in communication with the interior 26 of the resultant container 10. However, the channel 54 could be formed to pinch off the handle ends to form a handle 40 sealed at both ends relative to the interior 26 of the container 10. This could be done by including appropriately butting or nearly abutting surfaces at the opposite ends of the channel 54. Alternatively, the handle 40 can be sealed at its ends by any other well known process such as manual pinching upon extraction from the mold, or pinch off during a mold extraction.

In the illustrated embodiment, the core exteriors 60b, 62b of the core halves 60 and 62 define a semi-spherical shape resulting in a concave or inverted dome recess 36. This shape is particularly advantageous because it does not include projecting surfaces upon which material could be trapped. This helps, for example, when trying to wash out the entire contents of a container. Further, this shape provides the minimal recess 36 into the container 10 while still permitting ample space between the handle 40 and the recessed container sidewall 28. The ample space increases the amount of room in which a hand can fit wherein the more room available, the better the grip available.

Because the recess 36 only sacrifices a minimal interior volume of the container 10, that amount of volume can easily be accommodated by sizing the outer diameter of the middle portion 34 to retain a consistent volume within the container 10. Thus, the container 10 can generally correspond to specifications for, e.g., the present assignee's model SR-7, but now including a recessed handle. Thus, container 10 would represent a variation of the SR-7 container, but would have a slightly larger diameter for the middle section, yet the outermost diameters of the top and bottom sections, the overall height, and geometric configurations of the top and bottom sections would be identical. Accordingly, by maintaining the geometric configuration, the same characteristics such as stability, loading and impact characteristics remain the same.

Because the core 52 extends into the interior of the mold cavity 46 when rotated into the fully extended position, an outer edge of the channel 54 preferably aligns with the exterior of the mold, or lies within the mold cavity 46. Accordingly, the edge of the channel 54 is planar with mold, or lies within the exterior of the sidewall 28 of the container 10 at that point. Thus, when the handle 40 forms, the handle 40 does not extend beyond the exterior of the mold and consequently does not extend beyond the container exterior 28.

It can be appreciated that while the handle 40 is shown in an orientation parallel to the axis of the container 10, a handle 40 oriented in another direction, e.g., orthogonal relative to the axis could be formed. In that case, the handle forming channel 54 may be curved to follow the outer circumference of the container 10. Alternatively, the handle 40 could be linear and cut across and arc in the side of the container sidewall.

The method described above may also employ a blow pocket (not shown) having a rupture vent (not shown) which allows for the escape of excess air pressure upon the completion of the molding of the container 10. Additionally, knock-out pin counterbores (not shown) may constitute minor projections for knock-out pins (not shown) on the mold 46 to remove the container 10 after its molding.

Additionally, while in the above-described method both core halves 60 and 62 are described as being movable, it is also possible to design a mold half in which one of the core halves is fixed in the extended position. In that case, the core have its abutting face along the mold or parting line of the mold half as the container would be extracted perpendicularly relative to the core half abutting face.

Post preparation of the container 10 involves removing the various sections of flash and the blow pocket. In most areas, the mold squeezes the plastic along the edge of the container 10 so that the excess may undergo facile removal. However, the additional plastic attached to the neck 14 must be cut off and the neck 14 itself receive normal shaping.

In another embodiment, the at least one core 52 with the respective core halves 60, 62 may be externally mounted to the modular section 50. In this method, the core 52 may connect to the mold prior to closing the mold halves. Once mounted, the recess 36 and handle 40 core processed as disclosed. In this method, the core halves 60, 62 remain in the extended position after the blow molding process. After the blow molding process, the mold halves separate to expose the container 10. Since the externally mounted core 52 remains connected to the container 10, the core 52 may manipulate the container 10 and transport the container 10 out of the mold to another process station such as a conveyor system.

The present invention provides an excellent improvement to a container such as the SR-7 container and a method of manufacturing such a container. During use, the recessed handle 40 of the present invention makes handling, such as loading, transporting and unloading, more efficient for the user since the user can easily grasp the handle 40 via the recess 36. Additionally, the recessed handle 40 makes shipping and stocking the container 10 more efficient. Still further, the modular section 50 of the present invention makes manufacturing the container 10 more economical and efficient. Additionally, volume adjustments can be easily incorporated by changing the shape of the core halves 60, 62. Still further, the volume of the container may be maintained by adjusting the diameter of middle portion 34 by conveniently adjusting the shape of the modular section 50.

During handling, the recessed handle 40 eliminates unnatural and unsafe conditions during lifting and transporting. Additionally, the recessed handle 40 eliminates any extra component such as a harness which leads to saved labor steps. During shipping, the recessed handle 40 eliminates any need for custom shipping racks since the handle 40 does not extend beyond the container exterior 28. Accordingly, standard racks for nonhandled container may be used for the improved container 10. Additionally, the improved container 10 easily slides out the rack since the handle 40 does not extend beyond the container exterior 28. Similar, during stocking, the recessed handle 40 eliminates unnecessary space since the handles do not extend beyond the container exterior 28. Accordingly, improved containers 10 can stack adjacent to each other.

During manufacturing, the modular section 50 provides an efficient method of making handled and non handled containers. Additionally, the method provides that the reduced handle 40 of the middle portion 34 allows the volume adjustment to be incorporated in the modular section 50. Thus, the top and bottom mold sections, relating to the first portion 30 and the second portion 32, remain unchanged from a non-handled mold. Accordingly, only the modular section 50 requires manufacturing wherein the basic mold design of the present invention can manufacture two different types of containers by easily interchanging the modular section 50.

Additionally, the improved manufacturing method positions the handle 40 between the ribs 38 wherein the ribs 38 are not interrupted to accommodate the handle 40 and recess 36. Accordingly, the improved method eliminates any significant reduction of advertising space. Still further, the improved method reduces the weight of the container 10 without a significant volume reduction.

For aesthetic and marketing purposes, the improved container provides a handle 40 which is less noticeable when placed on a cooler with the label facing the user. Additionally, since the recessed handle 40 and recess 36 do not interrupt the continuity of the container 10, the improved container 10 provides the same allowable advertising space as a non-handled container. Existing handled containers require a reduction in the size of the advertising label or require an offset application to prevent the advertising label from overlapping a parting line of the handle mold. The present invention, however, provides the same advertising space due to the modular section 50 of the mold.

Accordingly, due to the shape of the handle 40 and the recess 36, the present invention provides a novel container 10 to hold substances. Further, due to the dimensional relationship of the handle 40 and exterior 28 of the container 10, the present invention provides an improved container 10 that is convenient to carry. Accordingly, the container 10 will provide efficient loading, transporting and unloading.

The exemplary embodiments described herein are provided merely to illustrate the principles of the invention and should not be construed as limiting the invention. The specification and drawings are, accordingly, to be regarded in an illustrative. Moreover, the principles of the invention may be applied to achieve the advantages described herein and to achieve other advantages or to satisfy other objectives, as well.

Although modifications and changes may be suggested by those skilled in the art, it is the intention of the inventors to embody within the patent warranted hereon all changes and modifications as reasonably and properly come within the scope of their contribution to the art.

I claim:

1. A container comprising a sidewall having an outer surface, a recess and a handle formed in the recess, the handle not extending beyond an outer surface of the container.

2. The container of claim 1, wherein the handle is hollow.

3. The container of claim 1 wherein the recess is substantially semi-spherical.

4. The container of claim 1, wherein the handle is integrally formed within the recess.

5. The container according to claim 1, wherein the container is blow molded plastic.

6. A blow molded section, comprising:
a modular section;
at least one core, the at least one core positioned within the modular section; and
an actuator, the actuator connected to the at least one core to move the at least one core within the modular section.

7. The blow molded section according to claim 7, wherein the modular section comprises a first modular face and a second modular face.

8. The blow molded section according to claim 7, wherein the at least one core comprises a first core half and a second core half.

9. The blow molded section according to claim 7, wherein the at least one core comprises a first core exterior and a second core exterior.

10. A method of manufacturing a container, comprising:
inserting a modular section into a mold;
moving at least one core of the modular section into a position; and
directing parison into a channel of the at least one core to form a handle.

11. The method according to claim 10, further comprising directing the parison around the at least one core to form an recess.

12. The method according to claim 10, further comprising moving the at least one core to another position to expose the recess.

13. The method according to claim 10, further comprising removing the container from the mold.

14. The method according to claim 10, wherein the position of the at least one core is a fully extended position into the modular section.

15. The method according to claim 12, wherein the other position is a fully retracted position out of the modular section.

16. The method according to claim 10, wherein moving the at least one core comprises rotating the at least one core by an actuator.

17. The method according to claim 10, wherein the at least one core travels along a guide rail positioned within the modular section.

18. The method according to claim 10, wherein the at least one core travels along the guide rail by a bearing.

19. The method according to claim 10, wherein the at least one core comprises a first core half and a second core half wherein the first core half and the second core half have faces which meet to partially form the channel.

20. The method according to claim 19, wherein the first core half and the second core half are semi-spherical shaped.
